(19) United States
(12) Patent Application Publication
(10) Pub. No.: US 2008/0025830 A1
(43) Pub. Date: Jan. 31, 2008

(54) Mounting device for an implement

(76) Inventors: Kevin E. Pielmeier, Cary, NC (US); Michael Pepe, Chapel Hill, NC (US)

Correspondence Address: Caterpillar Inc.;Intellectual Property Dept., AB 6490, 100 N.E. Adams Street, PEORIA, IL, 61629-6490, US

(21) Appl. No.: 11/492,239

(22) Filed: Jul. 25, 2006

(51) Int. Cl. B66C 23/00

(52) U.S. Cl. 414/723

(57) ABSTRACT

An implement for a machine is provided. The machine has at least one lift arm and a front end having a step. The implement has a frame removably mounted to the at least one lift arm. The lift arm also has at least one hook assembly mounted to the frame and removably mounted to the step.

### TECHNICAL FIELD

This invention relates generally to a mounting device for an implement, and more particularly, to a secondary attachment for a removable implement mounted to a skid steer loader.

### BACKGROUND

Machines such as skid steer loaders, integrated tool carriers, backhoe loaders, excavators, and a wide variety of other machines typically have a plurality of hydraulically controlled implements that may be interchangeably attached to perform a particular work function. These implements are normally removably attached to the machine through a coupler mounted to a pair of lift arms. While this attachment through the coupler adequately secures most implements, some implements, such as backhoe attachments for skid steers, may exert large downforces with respect to the machine. These downforces may overpower the hydraulic circuits of the lift arms, leading to undesired movement of the lift arms.

Implements having secondary attachments have been disclosed, for example, in U.S. Pat. No. 5,004,398 to Wagner (“Wagner). For the primary attachment, Wagner attaches the coupler of a skid steer loader to an overhanging member on the implement. In addition, Wagner provides a secondary attachment by mounting a pair of hook assemblies onto the frame of the skid steer loader. These hook assemblies engage projecting lugs on the implement frame. A separate locking assembly releasibly secures the lugs to the hook assemblies. While Wagner provides for a secondary attachment, Wagner also mounts a separate operator's chair to the implement outside of the protective cab enclosure. In addition, Wagner requires that the hook assemblies be mounted to the frame of the skid steer loader.

U.S. Pat. No. 4,117,944 to Beckstrom (“Beckstrom”) provides for a backhoe mounting assembly that permits the operator to control the machine while he is within the confines of the cab. However, as with Wagner, Beckstrom requires that a pair of mounting brackets be mounted to the frame of the machine. These brackets must be retrofitted onto existing machines or integrally formed in the frame of new machines. In addition, when the implements are removed from the machines, these brackets still project from the frame of the machine and may possibly catch on a bucket load or interfere with an operator's ingress or egress into the machine.

The present invention is directed to overcome one or more of the problems as set forth above.

### SUMMARY OF THE INVENTION

In one aspect of the present invention, an implement for a machine is provided. The machine has at least one lift arm and a front end having a step. The implement has a frame removably mounted to the at least one lift arm. The implement also has at least one hook assembly mounted to the frame and removably mounted to the step.

In another aspect of the present invention, a machine has a front end and has at least one lift arm, a step, a frame, and at least one hook assembly. The step is positioned at the front end. The frame is removably mounted to the at least one lift arm. The at least one hook assembly is mounted to the frame and removably mounted to the step.

A third aspect of the present invention includes a method of attaching an implement to a machine, where the machine has at least one lift arm and a front end having a step, and the implement has at least one hook assembly mounted to a frame. The method includes the step of removably mounting a frame to the at least one lift arm through a coupler. The method also includes the step of removably mounting the at least one hook assembly to the step.

### BRIEF DESCRIPTION OF THE DRAWINGS

FIG. 1 is a diagrammatic illustration of a machine having an implement with mounting device suitable for use with the present invention.

FIG. 2 is a detail view of the mounting device of FIG. 1.

FIG. 3 is a detail view of the hook assembly of the mounting device of FIG. 1.

### DETAILED DESCRIPTION

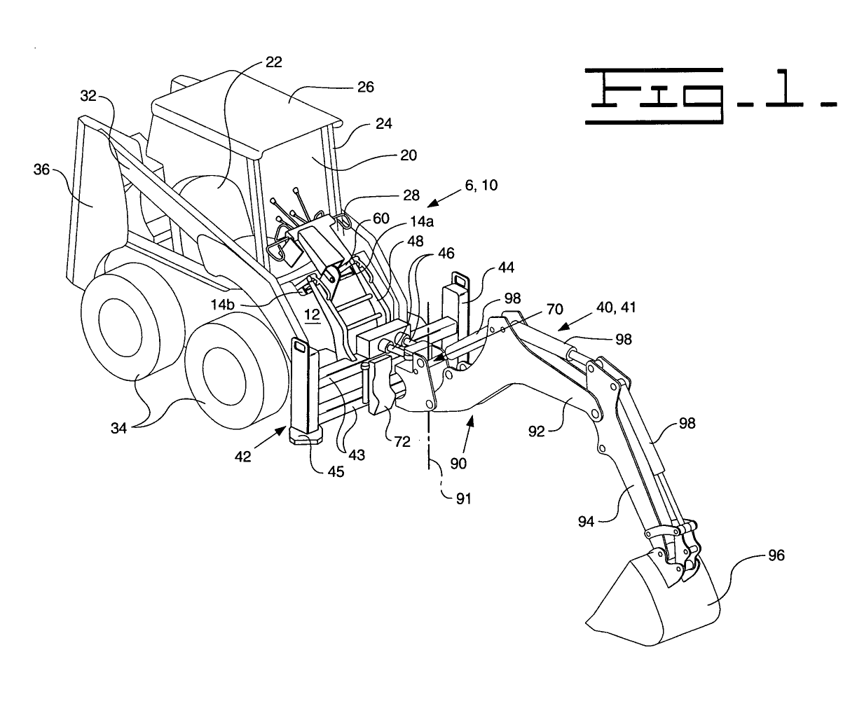

A machine 6 such as a skid steer loader 10 in accordance with the present invention is illustrated in FIG. 1. As shown, the skid steer loader 10 includes a body portion 12, steps 14A, 14B, an operator compartment 20, and a lift arm assembly 32. Front and rear sets of wheels 34 are mounted to stub axles (not shown) that extend from each side of the body portion 12. The lift arm assembly 32 is pivotally mounted to laterally spaced side members or uprights 36 at the rear of the body portion 12 and pivotally carries an implement 40 via a coupler (not shown). It should be recognized that the skid steer loader 10 could be belt/track driven or could have a belt entrained around front and rear wheels 34.

The operator compartment 20 may include a rollover protective structure (ROPS) and/or a falling object protective structure (FOPS) enclosing an operator seat 22. A pair of posts 24 and an overhead guard 26 may frame an optional door (not shown). The operator compartment 20 also includes an operator interface 28 in proximity to the seat for controlling the wheels 34 for propelling the vehicle and the lift arm assembly 32.

In FIG. 1, the implement 40 is depicted as a backhoe attachment 41 removably attached to the skid steer loader 10. The implement includes a frame 42, a sideshift assembly 70, and a linkage 90 having a boom 92, stick 94, and bucket 96 driven by hydraulic actuators 98. The frame 42 is removably attached to the skid steer loader 10 through the coupler (not shown), forming a primary attachment. In addition, a pair of beams 48 extend from the frame 42 and terminate in a pair of hook assemblies 60 through a clevis arrangement. The hook assemblies 60 are hooked onto the steps 14A, 14B of the skid steer loader 10 and provide a secondary attachment. This secondary attachment also restrains the lift arm assembly 32 and coupler (not shown) against the skid steer loader 10 when an operator operates the implement 40.

As seen in FIG. 1, the sideshift assembly 70 is mounted to the frame 42 through a carrier 72. The carrier 72 is slidably mounted to a plurality of transverse rails 43 in the frame 42. The transverse rails 43 are connected to a pair of struts 44 that support the implement 40. Each of the struts 44 has an adjustable footpad 45 to level the implement 40. In addition, actuators 46 may rotate the linkage 90 about a vertical axis 91, pivoting it left and right with respect to the skid steer loader 10.

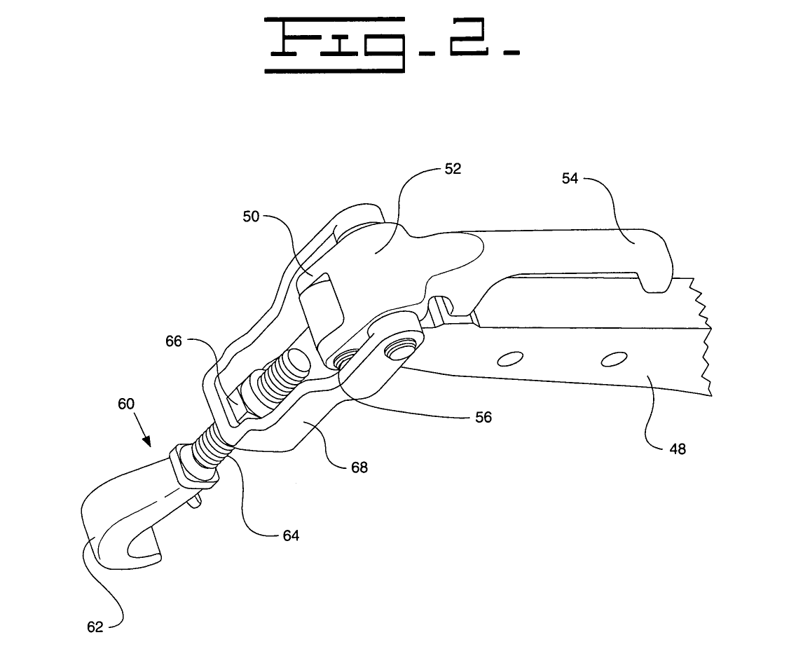

As best seen in FIG. 2, each of the beams 48 are pinned to a lever portion 50 that extends from the end 52 of a handle 54 through a pin 56, such that handle 54 may rotate about the pin 56 through a clevis pin arrangement. The hook assembly 60, including a hook 62, a threaded rod 64, a nut 66, and a clevis 68, is pinned to the end 52 of the handle 54 through the clevis 68. One end of the threaded rod 64 is adjustably secured to the clevis 68 by the nut 66, while the other end of the threaded rod 64 terminates in the hook 62.

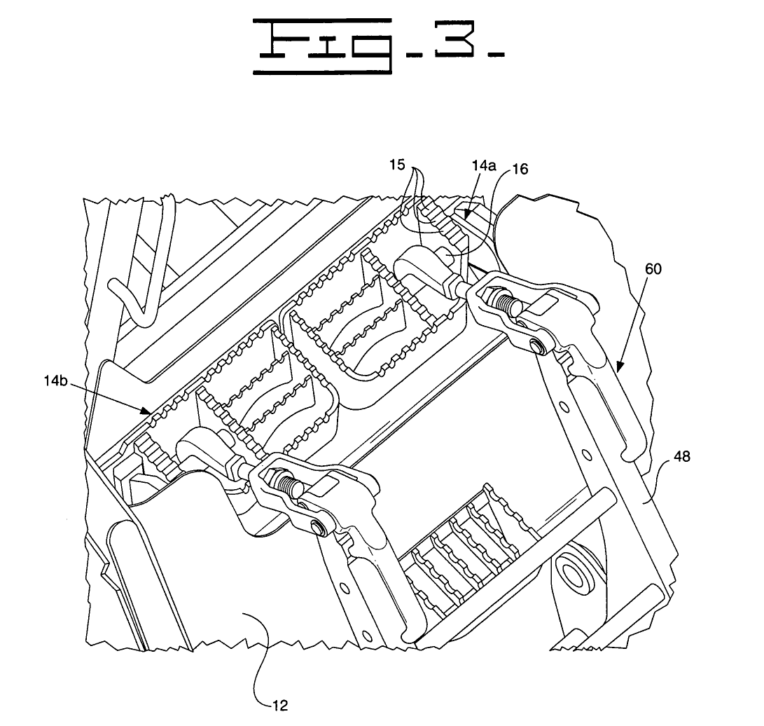

As best seen in FIG. 3, the hooks 62 are removably attached to the steps 14A, 14B. The steps 14A, 14B are mounted to the body portion 12 of the skid steer loader 10. The steps 14A, 14B are formed from plates having notches 15 on the uppermost surfaces to form treads. A transverse pin 16 extends along the width of the steps 14A, 14B. As shown in FIG. 3, the left step 14A may be formed as a mirror image of the right step 14B, although other configurations may also be used. The steps 14A, 14B may be formed as a retrofit item, where originally installed steps (not shown) may be simply removed by loosening a plurality of bolts (not shown) that secure it to the body portion 12, or alternately, the steps 14A, 14B may be integrally formed in the body portion 12 of the machine 6. The steps 14A, 14B may be formed from steel, iron, or some other metal or composite material.

### INDUSTRIAL APPLICABILITY

In operation, an operator first connects the coupler (not shown) of the machine 6 to the frame 42 of the implement 40. The operator then connects the hook assemblies 60 to the steps 14A, 14B, providing for a secondary attachment. This secondary attachment also secures the lift arm assembly 32 and coupler (not shown) against the skid steer loader 10 while the implement 40 is in operation. The hook assemblies 60 may be secured to the transverse pins 16 of the steps 14A, 14B by rotating the handle 54 upwards and by adjusting the nuts 66 on the threaded rods 64.

An operator may enter the operator compartment or cab 20 by climbing up steps 14A, 14B, lifting up operator interface 28, and sitting in the seat 22. In this position, the operator may operate the implement 40 using the operator interface 28 while remaining within the protective confines of the provided ROPS or FOPS.

Several advantages over the prior art may be associated with the mounting device for an implement 40. The disclosed steps 14A, 14B and hook assemblies 60 allow the implement 40 to be quickly and easily attached or removed from the machine 6. In addition, when the implement 40 is removed, the transverse pins 16 are integrated with the steps 14A, 14B, blending in with the machine 6.

Other aspects, objects and advantages of this invention can be obtained from a study of the drawings, the disclosure, and the appended claims.

What is claimed is:

1. An implement for a machine, the machine having at least one lift arm and a front end having a step, comprising:
a frame removably mounted to the at least one lift arm; and
at least one hook assembly mounted to the frame and removably mounted to the step.

2. The implement of claim 1 further comprising:
a side shift assembly mounted to the frame;
a linkage slidably mounted to the side shift assembly; and
a work tool mounted to the linkage.

3. The implement of claim 1, wherein the machine is a skid steer loader.

4. The implement of claim 1, wherein the step has a transverse pin and the at least one hook assembly is removably mounted to the transverse pin.

5. The implement of claim 1 further comprising:
a lever assembly mounted to the frame and selectively engaging the at least one hook assembly.

6. The implement of claim 2, wherein the machine is a skid steer loader.

7. The implement of claim 2, wherein the step has a transverse pin and the at least one hook assembly is removably mounted to the transverse pin.

8. The implement of claim 2 further comprising:
a lever assembly mounted to the frame and selectively engaging the at least one hook assembly.

9. A machine having a front end and comprising:
at least one lift arm;
a step positioned at the front end;
a frame removably mounted to the at least one lift arm; and
at least one hook assembly mounted to the frame and removably mounted to the step.

10. The machine of claim 9 further comprising:
a side shift assembly mounted to the frame;
a linkage slidably mounted to the side shift assembly; and
a work tool mounted to the linkage.

11. The machine of claim 9, wherein the machine is a skid steer loader.

12. The machine of claim 9, wherein the step has a transverse pin and the at least one hook assembly is removably mounted to the transverse pin.

13. The machine of claim 9 further comprising:
a lever assembly mounted to the frame and selectively engaging the at least one hook assembly.

14. The machine of claim 10, wherein the machine is a skid steer loader.

15. The machine of claim 10, wherein the step has a transverse pin and the at least one hook assembly is removably mounted to the transverse pin.

16. The machine of claim 10 further comprising:
a lever assembly mounted to the frame and selectively engaging the at least one hook assembly.

17. A method of attaching an implement to a machine, wherein the machine has at least one lift arm and a front end having a step, and wherein the implement has at least one hook assembly mounted to a frame, comprising the steps of:
removably mounting a frame to the at least one lift arm through a coupler; and
removably mounting the at least one hook assembly to the step.

18. The method of claim 17, wherein the implement is a backhoe attachment and wherein the machine is a skid steer loader.
